(19) United States
(12) Patent Application Publication
(10) Pub. No.: US 2021/0140605 A1
(43) Pub. Date: May 13, 2021

(54) OPTICAL ELEMENT AND OPTICAL-SYSTEM APPARATUS

(71) Applicant: SCIVAX CORPORATION, Kanagawa (JP)

(72) Inventors: Akifumi Nawata, Kanagawa (JP); Satoru Tanaka, Kanagawa (JP)

(21) Appl. No.: 16/620,711

(22) PCT Filed: Dec. 14, 2018
(86) PCT No.: PCT/JP2018/046053

§ 371 Date: Dec. 9, 2019

(30) Foreign Application Priority Data
Dec. 14, 2017 (JP) 2017-239917

(51) Int. Cl. F21V 5/04; F21V 7/06

(52) U.S. Cl. CPC F21V 5/045; F21V 7/06

(57) ABSTRACT

An optical element with which it is possible to control not only the light emission direction but also the illuminance, and an optical system device in which the optical element is used. An optical element having at least a part of a rotation body obtained by rotating a reference planar shape for converting light from a prescribed location into light that is parallel with a prescribed direction, or a parallel translation body obtained by performing a parallel translation on the reference planar shape, wherein: the reference planar shape has an illuminance adjustment part and an emission direction adjustment part; the illuminance adjustment part is shaped so as to convert the direction of light entering from the prescribed location so that the illuminance at the emission direction adjustment part is uniform; and the emission direction adjustment part is shaped so as to convert the direction of light to the prescribed direction by refraction.

### TECHNICAL FIELD

The present disclosure relates to an optical element and an optical-system apparatus that utilizes the same.

### BACKGROUND ART

In recent years, LEDs are utilized as a light source for lighting. In accordance with this trend, development of an optical-system apparatus that guides light frontward without a waste is advancing. For example, an optical apparatus has been proposed which includes a refraction lens unit and a plurality of reflector units (e.g., Patent Document 1).

### CITATION LIST

### Patent Literatures

[Patent Document 1] JP H5-281402 A

### SUMMARY OF INVENTION

### Technical Problem

However, the light distribution characteristic of general surface-emitting light sources like LEDs are Lambertian light distribution. Hence, if light is guided merely frontward, there is a technical problem such that the lighting intensity becomes uneven.

Accordingly, an objective of the present disclosure is to provide an optical element capable of controlling not only the emitting direction of light but also the lighting intensity, and an optical-system apparatus that utilizes the same.

### Solution to Problem

An optical element according to the present disclosure includes: at least a part of a rotating body obtained by rotating a reference planar shape that converts light from a predetermined site into parallel light to a predetermined direction, or of a parallel displacement body obtained by parallel displacement of the reference planar shape,

in which the reference planar shape includes a lighting intensity adjuster and a light emitting direction adjuster,

in which the lighting intensity adjuster is formed in a shape that converts a direction of incident light from the predetermined site in such a way that a lighting intensity at the light emitting direction adjuster becomes uniform, and

in which the light emitting direction adjuster is formed in a shape that converts the direction of light in the predetermined direction by refraction.

In this case, the lighting intensity adjuster includes a first light entering portion that is formed in a shape which refracts the incident light from the predetermined site in such a way that a lighting intensity on a reference line where a distance in the predetermined direction from the light emitting direction adjuster is less than 100μm becomes uniform. Moreover, the lighting intensity adjuster may include: a second light entering portion in which the light from the predetermined site enters; and a reflector that reflects the light having passed through the second light entering portion in such a way that a lighting intensity on a reference line where a distance in the predetermined direction from the light emitting direction adjuster is less than 100 μm becomes uniform. It is preferable that the second light entering portion should be a circular arc around the predetermined site. Furthermore, it is preferable that the reflector should be formed in a shape that causes total reflection on the light having passed through the second light entering portion, but the reflector may utilize metal reflection.

Moreover, the light emitting direction adjuster may include a concavo-convex structure that does not cause a diffraction.

Furthermore, the lighting intensity adjuster converts the direction of incident light with Lambertian light distribution from the predetermined site so as to make the lighting intensity on the reference line uniform.

An optical-system apparatus according to the present disclosure includes:

the above-described optical element according to the present disclosure; and

a light source placed at the predetermined site.

The optical-system apparatus may further include:

a first lens that concentrates parallel light emitted from the optical element;

an aperture that has a smaller opening than a width of the light concentrated by the first lens; and

a second lens that returns the light having passed through the opening of the aperture to the parallel light again.

The optical-system apparatus may further include an aperture which is placed between the light source and the optical element, and which has a smaller opening than a width of light emitted from the light source.

### Advantageous Effects of Invention

According to the present disclosure, the optical element and the optical-system apparatus utilizing the same form the lighting intensity adjuster that controls the lighting intensity of light, and the light emitting direction adjuster that controls the direction of the light. Accordingly, not only the light emitting direction but also the lighting intensity can be controlled.

### BRIEF DESCRIPTION OF DRAWINGS

FIG. 1 is a diagram illustrating a reference planar shape according to an optical element of the present disclosure;

FIG. 2 is a perspective view illustrating the optical element (a rotating body) according to the present disclosure;

FIG. 3A is a side view and FIG. 3B is a plan view both illustrating the optical element (the rotating body) according to the present disclosure;

FIG. 4 is a perspective view illustrating the optical element (a parallel displacement body) according to the present disclosure;

FIG. 5 is a perspective view illustrating another optical element (a parallel displacement body) according to the present disclosure;

FIG. 6A is a side view and FIG. 6B is a plan view both illustrating the optical element (the parallel displacement body) according to the present disclosure;

FIG. 7 is a diagram for describing how to decide a reference line;

FIG. 8 is a diagram for describing a lighting intensity unevenness Ia;

FIG. 9 is a diagram for describing a lighting intensity unevenness Iz;

FIG. 10 is a partial schematic enlarged view illustrating a light emitting direction adjuster according to the present disclosure;

FIG. 11 is a diagram illustrating a reference planar shape according to another optical element of the present disclosure;

FIG. 12 is a perspective view illustrating another optical element (a rotating body) according to the present disclosure;

FIG. 13 is a cross-sectional view for describing an optical-system apparatus according to the present disclosure;

FIG. 14 is a schematic side view for describing another optical-system apparatus according to the present disclosure;

FIG. 15 is a schematic side view for describing further another optical-system apparatus according to the present disclosure; and

FIG. 16 is a diagram illustrating a lighting intensity distribution of the optical-system apparatus according to the present disclosure.

### DESCRIPTION OF EMBODIMENTS

An optical element 10 according to the present disclosure will be described. The optical element 10 according to the present disclosure is a rotating body (e.g., see FIGS. 2 and 3A & B) obtained by rotating a planar shape that becomes a reference (a reference planar shape 1 below, e.g., see FIG. 1) or is a parallel displacement body (see FIGS. 4 to 6A & B) obtained by parallel displacement thereof, and converts light from a predetermined site to parallel light to a predetermined direction (a y-axis direction in FIG. 1). In this case, it is appropriate if the optical element 10 includes at least a part of the rotating body of the reference planar shape 1 or of the parallel displacement body thereof. When, for example, the optical element 10 is formed by injection molding, since a gate that is an injection inlet to apply a resin is necessary, a cut surface from which the gate is cut out is formed in a finished product, but the optical element 10 according to the present disclosure covers such a structure that has the cut surface.

The material of the optical element 10 is not limited to any particular material as long as it is transparent relative to light subjected to control, but for example, a transparent dielectric is applicable. More specifically, an inorganic substance like glass, and a resin like cycloolefin polymer (COP) are such materials.

The reference planar shape 1 converts light from a predetermined site into parallel light to a predetermined direction (the y-axis direction in FIG. 1), and as illustrated in FIG. 1, includes at least a lighting intensity adjuster 2, and a light emitting direction adjuster 3. Note that in FIG. 1, for the purpose of description, a predetermined site 9 is defined as an origin 0, the right direction from the origin O on the paper plane is defined as an x-axis, the upper direction is defined as a y-axis, and the depthwise direction is defined as a z-axis.

The lighting intensity adjuster 2 converts the direction of incident light from the predetermined site 9 in such a way that an lighting intensity on the light emitting direction adjuster 3 or on a reference line where a distance in a predetermined direction from the light emitting direction adjuster 3 is less than 100 μm becomes uniform. When the direction of incident light from the predetermined site 9 is converted, light distribution of a light source placed at the predetermined site 9 is also taken into consideration. For example, it is known that, as for LEDs, the light distribution becomes Lambertian light distribution. Hence, when the optical element 10 according to the present disclosure is applied together with LEDs, it is appropriate if a shape is adopted in such a way that the direction of incident light from the predetermined site 9 with the Lambertian light distribution is converted so as to attain a uniform lighting intensity on the light emitting direction adjuster 3 or on the reference line where the distance in the predetermined direction from the light emitting direction adjuster 3 is less than 100 μm.

As for such a lighting intensity adjuster 2, a first light entering portion 21 that is formed in a shape which refracts incident light from the predetermined site 9 in such a way that the lighting intensity on the light emitting direction adjuster 3 or on the reference line where the distance in the predetermined direction from the light emitting direction adjuster 3 is less than 100 μm becomes uniform. In this case, the shape of the first light entering portion 21 is not limited to any particular shape as long as the lighting intensity on the light emitting direction adjuster 3 or on the reference line where the distance in the predetermined direction (the y-axis direction in FIG. 1) from the light emitting direction adjuster 3 is less than 100 μm becomes constant. Needless to say, with the light distribution of the light source placed at the predetermined site 9 being taken into consideration, a shape is preferable which converts the direction of light in such a way that the lighting intensity on the light emitting direction adjuster 3 or on the reference line where the distance in the predetermined direction from the light emitting direction adjuster 3 is less than 100 μm becomes uniform.

Moreover, when the angle of incident light from the predetermined site 9 to the first light entering portion 21 increases, more lights are reflected and wasted. In such a case, the lighting intensity adjuster 2 may include a second light entering portion 22 that allows the light to enter from the predetermined site 9, and a reflector 23 that reflects the light which has passed through the second light entering portion 22 in such a that the lighting intensity on the light emitting direction adjuster 3 or on the reference line where the distance in the predetermined direction from the light emitting direction adjuster 3 is less than 100 μm becomes uniform.

Needless to say, the lighting intensity adjuster 2 may include both the first light entering portion 21, and the set of the second light entering portion 22 and reflector 23.

The shape of the second light entering portion 22 is not limited to any particular shape as long as it can guide light from the predetermined site 9 to the reflector 23, but a shape that reduces reflection of light from the predetermined site 9 as much as possible is preferable. Hence, the most preferable shape of the second light entering portion 22 is a circular arc around the predetermined site 9. This causes the light from the predetermined site 9 to enter the second light entering portion 22 vertically, and thus the reflection can be maximally suppressed.

The shape of the reflector 23 is not limited to any particular shape as long as it is formed in such a way that the lighting intensity on the light emitting direction adjuster 3 or on the reference line where the distance in the predetermined direction from the light emitting direction adjuster 3 is less than 100 μm becomes constant. Needless to say, with the light distribution of the light source placed at the predetermined site 9 being taken into consideration, a shape is preferable which converts the direction of the light that has passed through the second light entering portion 22 in such a way that the lighting intensity on the light emitting direction adjuster 3 or on the reference line where the distance in the predetermined direction from the light emitting direction adjuster 3 is less than 100 μm becomes uniform.

Moreover, although the reflector 23 may utilize metal reflection, a loss due to absorption of light energy occurs. Hence, it is preferable that the reflector 23 should perform total reflection on the light which has passed through the second light entering portion 22. The reflector 23 that causes the incidence angle of the light received from the predetermined site 9 through the second light entering portion 22 to be equal to or greater than a critical angle can utilize total reflection. When, for example, a transparent dielectric that forms the optical element 10 is cycloolefin polymer (COP), since the index of refraction is 1.41, the critical angle becomes substantially 45 degrees.

Note that although whether or not the lighting intensity is uniform is determined at the light emitting direction adjuster 3, whether or not the lighting intensity of the light emitting direction adjuster 3 that is formed in a concavo-convex shape like a Fresnel lens is uniform may be determined by the following method.

First, the reference planar shape 1 is decided. Regarding the reference planar shape 1, when the optical element 10 is the rotating body, a cross section of the rotating body including the center (a rotation axis) becomes the reference planar shape 1. Moreover, when the optical element 10 is a parallel displacement body, a cross section in the parallel displacement body that is a vertical plane to the direction in which parallel displacement is carried out becomes the reference planar shape 1.

Next, the reference planar shape 1 is taken into an optical simulation software. An example optical simulation software applicable is LightTools (available from Synopsys inc.).

Next, a vertical reference line 25 to the predetermined direction (the y-axis) is decided on the reference planar shape 1. As illustrated in FIG. 7, the reference line 25 can be calculated and obtained by least square from points 32 at the bottom of a concavo-convex structure 31 of the light emitting direction adjuster 3 (points at the-lighting-intensity-adjuster-2 side). In this case, peculiar points that remarkably differ may be excluded.

Next, a relationship between a position on the reference line 25 when the light source applied for the optical element 10 is placed at the predetermined site 9, and the lighting intensity is calculated.

Subsequently, a lighting intensity average line calculated by least square from a graph of the light distribution, and its lighting intensity unevenness Ia are calculated. As illustrated in FIG. 8, Ia is obtained by the following formula when only a reference length L1 is taken out from the graph of lighting intensity distribution in the direction of the lighting intensity average line, the x-axis and the y-axis are taken in the direction of the average line in the taken-out part and in the direction of the longitudinal magnification, the graph of the lighting intensity distribution is expressed as y=f (x), and a value obtained by the following formula is represented by a watt per square millimeter (W/mm²). Note that the reference length L1 is at least equal to or greater than 50% of the length of the lighting intensity average line.

$$Ia = 1 L 10 L 1 fxdx I a = \frac{1}{L 1} {\int }_{0}^{L 1} \{ f ( x ) \} d x \qquad [ Formula 1 ]$$

However, as illustrated in FIG. 9, instead of Ia, in a simpler scheme, only the reference length L1 is taken out in the direction of the lighting intensity average line of the light distribution, a sum of the average value of the absolute values of the altitudes (Zp) of a group of the mountain tops from the highest mountain top to the fifth mountain top measured in the direction of the longitudinal magnification from the lighting intensity average line of this taken-out part, and the average value of the absolute values of the altitudes (Zv) from the lowest mountain bottom to the fifth mountain bottom, and a formula of the average lighting intensity of the following ten points that represents the value of such a sum by watt per square millimeter (W/mm²) may be utilized.

$$Iz = \frac{( Zp 1 + Zp 2 + ⋯ + Zp 5 ) + ( Zv 1 + Zv 2 + ⋯ + Zv 5 )}{5} \qquad [ Formula 2 ]$$

When Ia or Iz calculated as described above is equal to or smaller than 0.001 (W/mm²), preferably, equal to or smaller than 0.0005 (W/mm²), the lighting intensity can be considered as uniform.

The light emitting direction adjuster 3 converts the direction of light to the predetermined direction by refraction. For example, it may be in a shape that refracts light in the y-axis direction of the reference planar shape.

Moreover, in order to achieve a uniform lighting intensity of emitted light, it is preferable that the light emitting direction adjuster 3 should be as close as possible to the reference line 25. Hence, it is preferable that the light emitting direction adjuster 3 should be the concavo-convex structure 31 that has a distance h from the reference line 25 which is less than 100 μm, preferably, less than 50 μm (see FIG. 10). Moreover, when the shape of the light emitting direction adjuster 3 is the concavo-convex structure 31, it is preferable that a pitch p of the concavo-convex structure 31 provided on the reference line 25 should have a size that does not cause diffraction in light from the light source placed at the predetermined site 9. More specifically, it is preferable that the pitch p of the concavo-convex structure 31 should be equal to or greater than 50 μm, preferably, equal to or greater than 100 μm.

Note that the light emitting direction adjuster 3 is not limited to the Fresnel shape like the concavo-convex structure 31, and for example, as illustrated in FIGS. 11 and 12, may be a curved line. In this case, in an actual manufacturing, a disadvantage such that the corner of the concavo-convex structure 31 is rounded, and the efficiency decreases does not occur. Moreover, in comparison with the case of the concavo-convex structure, the manufacturing costs of metal molds can be suppressed. Furthermore, although the concavo-convex structure 31 has a disadvantage such that diffraction occurs when a size is reduced, in the case of the curved line, there is also an advantage such that diffraction is avoidable.

Moreover, although a connection 4 that connects the lighting intensity adjuster 2 and the light emitting direction adjuster 3 is not limited to any particular one, a connection that does not interfere an optical path is preferable.

Furthermore, as illustrated in FIG. 13, an optical-system apparatus 100 according to the present disclosure includes the above-described optical element 10 according to the present disclosure, and a light source 5 placed at the predetermined site 9 of the optical element 10.

In this case, the lighting intensity adjuster 2 of the optical element 10 converts, with the light distribution of the light source 5 being taken into consideration, the direction of light from the light source 5 in such a way that the lighting intensity on the light emitting direction adjuster 3 or on the reference line where the distance in the predetermined direction from the light emitting direction adjuster 3 is less than 100 μm becomes uniform. Accordingly, when the light distribution of the light source 5 is the Lambertian light distribution, the lighting intensity adjuster 2 is formed in a shape that converts the direction of incident light from the predetermined site 9 by the Lambertian light distribution in such a way that the lighting intensity on the light emitting direction adjuster 3 or on the reference line where the distance in the predetermined direction from the light emitting direction adjuster 3 is less than 100 μm becomes uniform.

Moreover, as illustrated in FIG. 14, another optical-system apparatus 110 according to the present disclosure includes the above-described optical element 10 according to the present disclosure, a first lens 60 that concentrates parallel light emitted from the optical element 10, an aperture 70 that is an opening smaller than the width of the concentrated light by the first lens 60, and a second lens 80 that returns the light which has passed through the opening of the aperture 70 to parallel light again. This achieves sharp edges of light to be emitted.

Moreover, as illustrated in FIG. 15, a further another optical-system apparatus 120 according to the present disclosure includes an aperture 90 which is placed between the light source 5 and the optical element 10, and which has an opening smaller than the width of light emitted from the light source 5. This achieves sharp edges of light to be emitted.

Next, examples of the optical element 10 according to the present disclosure will be described. The optical element 10 according to the present disclosure maybe formed as (1) the rotating body that has the reference planar shape 1 rotated around a center line that is a straight line passing through the predetermined site as illustrated in FIGS. 2 and 3, or (2) a parallel displacement body that has the reference planar shape 1 having undergone parallel displacement in the normal line direction of the reference planar shape 1 as illustrated in FIGS. 4 to 6A and 6B. In other words, in the rotating body (1), a cross section that includes the center line becomes the same shape as that of the reference planar shape 1. Moreover, in the parallel displacement body (2), a cross section by a vertical plane to a parallel displacement direction becomes the same shape as that of the reference planar shape 1.

First, the reference planar shape 1 in this case will be described. As illustrated in FIG. 1, the reference planar shape 1 includes the first light entering portion 21, the second light entering portion 22, the reflector 23 that are the lighting intensity adjuster 2, and the light emitting direction adjuster 3, and is formed in a shape that emits incident light from the predetermined site 9 as parallel light in the y-axis direction. The production method of the reference planar shape 1 is as follow.

First, the first light entering portion 21 is created as a curved line AB within a region where not so may light is reflected.

It is appropriate that the shape of the curved line AB should be designed in such a way that light refracted at an arbitrary point on the curved line AB has uniform lighting intensity on the light emitting direction adjuster 3 or on a straight line FG on the reference line where the distance in a predetermined direction from the light emitting direction adjuster 3 is less than 100 μm. More specifically, a calculation may be made in such a way that the lighting intensity on an arbitrary point on the light emitting direction adjuster 3 or on the straight line FG on the reference line where the distance in the predetermined direction from the light emitting direction adjuster 3 is less than 100 μm becomes the same value as the value obtained by dividing the integrated value of the lighting intensities on the curved line AB by the length thereof. As for such a calculation, an analysis method like the Newton-Raphson method is applicable. Moreover, such a calculation can be carried out by a computer.

Next, as the second light entering portion, a circular arc that has a center O and a radius r that is a straight line OB is created. The circular arc can be expressed by the following formula.

X²+y²=r² [Formula 3]

Next, a length of the light emitting direction adjuster 3 through which reflected light by the reflector 23 and having passed through the second light entering portion 22 passes or of the straight line GE on the reference line where the distance that is less than 100 μm in the predetermined direction from the light emitting direction adjuster 3 is calculated. In a case in which the reflection by the reflector 23 is total reflection, when the integrated value of the lighting intensities on the circular arc BC is divided by the lighting intensity on the above-described straight line FG, the length of the straight line GE can be calculated. Needless to say, when the reflection by the reflector 23 is metal reflection, it is necessary to consider a loss by absorption.

Next, a curved line CD is created as the reflector 23. It is appropriate to design the shape of the curved line CD in such a way that, regarding refracted light at an arbitrary point on the curved line CD, the lighting intensity becomes uniform on the light emitting direction adjuster 3 or on the straight line GE on the reference line where the distance in the predetermined direction from the light emitting direction adjuster 3 is less than 100 Such a calculation can adopt an analysis method like Newton-Rapson method. Moreover, such a calculation can be carried out using a computer.

Next, a curved line FE is created as the light emitting direction adjuster 3. The curved line FE can be designed in a shape that refracts light from the first light entering portion 21 and light from the reflector 23 into parallel light to the y-axis.

Eventually, the connection 4 that is ED which connects the lighting intensity adjuster 2 and the light emitting direction adjuster 3 to each other is created. ED can be in any shape as long as it does not disrupt the optical path.

The optical element according to the present disclosure becomes the rotating body as illustrated in FIGS. 2 and 3 when the reference planar shape 1 created as described above is rotated along the center line that is the y-axis.

Moreover, the optical element according to the present disclosure becomes the parallel displacement body as illustrated in FIG. 4 when the reference planar shape 1 is subjected to parallel displacement in the z-axis direction. In this case, it is preferable that the optical element should have the reference planar shape 1 which is mirror symmetry relative to the y-axis as illustrated in FIGS. 5, 6A and 6B.

Next, the light distribution when light is controlled using the optical-system apparatus 100 as illustrated in FIG. 11 was simulated. In this case, the optical element applied was, as illustrated in FIGS. 2 and 3, the rotating body which was obtained by rotating the reference planar shape 1 illustrated in FIG. 1, and which was to emit incident light from the predetermined site 9 as parallel light to the y-axis. The distance (OA) from the predetermined site 9 of the optical element 10 to the first light entering portion on the y-axis was 4 mm. Moreover, the distance (a radius OC) from the predetermined site 9 of the optical element 10 to the second light entering portion was 5.86 mm, and angle (ZBOC) of the circular arc that was the second light entering portion was 35 degrees. Furthermore, the distance (OF) between the predetermined site 9 and the reference line 25 was 10 mm, and the radius of the optical element 10 at the light-emitting-direction-adjuster side was 10 mm. Still further, the applied light source 5 placed at the predetermined site 9 had a diameter of 0.01 mm and was to emit light with Lambertian light distribution with emitted power of 1 W. The light distribution at a site apart from the light emitting direction adjuster by 50 mm was calculated. Note that an optical simulation software LightTools (available from Synopsys, Inc.) was applied for the simulation.

The simulation result is shown in FIG. 16. The lighting intensity unevenness was equal to or smaller than 0.0005 (W/mm²).

### REFERENCE SIGNS LIST

1 Reference planar shape

2 Lighting intensity adjuster

3 Light emitting direction adjuster

5 Light source

9 Predetermined site

10 Optical element

21 First light entering portion

22 Second light entering portion

23 Reflector

25 Reference line

31 Concavo-convex structure

60 First lens

70 Aperture

80 Second lens

90 Aperture

100 Optical-system apparatus

110 Optical-system apparatus

120 Optical-system apparatus

What is claimed is:

1. An optical element comprising: at least a part of a rotating body obtained by rotating a reference planar shape that converts light from a predetermined site into parallel light to a predetermined direction, or of a parallel displacement body obtained by parallel displacement of the reference planar shape,
wherein the reference planar shape comprises a lighting intensity adjuster and a light emitting direction adjuster,
wherein the lighting intensity adjuster is formed in a shape that converts a direction of incident light from the predetermined site in such a way that a lighting intensity at the light emitting direction adjuster becomes uniform, and
wherein the light emitting direction adjuster is formed in a shape that converts the direction of light in the predetermined direction by refraction.

2. The optical element according to claim 1, wherein the lighting intensity adjuster comprises a first light entering portion that is formed in a shape which refracts the incident light from the predetermined site in such a way that a lighting intensity on a reference line where a distance in the predetermined direction from the light emitting direction adjuster is less than 100 μm becomes uniform.

3. The optical element according to claim 1, wherein the lighting intensity adjuster comprises
a second light entering portion in which the light from the predetermined site enters; and
a reflector that reflects the light having passed through the second light entering portion in such a way that a lighting intensity on a reference line where a distance in the predetermined direction from the light emitting direction adjuster is less than 100 μm becomes uniform.

4. The optical element according to claim 3, wherein the second light entering portion is a circular arc around the predetermined site.

5. The optical element according to claim 3, wherein the reflector is formed in a shape that causes total reflection on the light having passed through the second light entering portion.

6. The optical element according to claim 3, wherein the reflector utilizes metal reflection.

7. The optical element according to claim 1, wherein the light emitting direction adjuster comprises a concavo-convex structure that does not cause a diffraction.

8. The optical element according to claim 1, wherein the lighting intensity adjuster converts the direction of incident light with Lambertian light distribution from the predetermined site so as to make the lighting intensity on the reference line uniform.

9. An optical-system apparatus comprising:
the optical element according to claim 1; and
a light source placed at the predetermined site.

10. The optical-system apparatus according to claim 9, further comprising
a first lens that concentrates parallel light emitted from the optical element;
an aperture that has a smaller opening than a width of the light concentrated by the first lens; and
a second lens that returns the light having passed through the opening of the aperture to the parallel light again.

11. The optical-system apparatus according to claim 9, further comprising an aperture which is placed between the light source and the optical element, and which has a smaller opening than a width of light emitted from the light source.
